(19) United States
(12) Patent Application Publication
(10) Pub. No.: US 2026/0162875 A1
(43) Pub. Date: Jun. 11, 2026

(54) ELECTRONIC COMPONENT

(71) Applicant: Murata Manufacturing Co., Ltd., Kyoto-fu (JP)

(72) Inventor: Kenta KONDO, Nagaokakyo-shi (JP)

(73) Assignee: Murata Manufacturing Co., Ltd., Kyoto-fu (JP)

(21) Appl. No.: 19/405,067

(22) Filed: Dec. 1, 2025

(30) Foreign Application Priority Data
Dec. 10, 2024 (JP) 2024-215911

(51) Int. Cl. H01F 27/28; H01F 27/32

(52) U.S. Cl. CPC H01F 27/2804; H01F 27/323; H01F 2027/2809

(57) ABSTRACT

An electronic component includes a body including a plurality of insulation layers laminated together and two or more conductor portions disposed on or in the body. The insulation layers each include a glass portion and an inorganic filler, at least one of the glass portion and the inorganic filler contains SiO₂, X₂O₃, and R₂O where X is at least one of Al and B, and R is an alkali metal atom, and the relationship indicated by M^{X2O3}/(M^{SiO2}+M^{X2O3})≤0.20 and M^{R2O}/(M^{SiO2}+M^{X2O3})≥0.008 is satisfied where M^{SiO2} is the mass of SiO₂, M^{X2O3} is the mass of X₂O₃, and M^{R2O} is the mass of R₂O satisfy.

### CROSS-REFERENCE TO RELATED APPLICATION

This application claims benefit of priority to Japanese Patent Application No. 2024-215911, filed Dec. 10, 2024, the entire content of which is incorporated herein by reference

### BACKGROUND

### Technical Field

The present disclosure relates to an electronic component.

### Background Art

Conventionally, studies have been conducted on inductor components including glass-based insulating materials. However, when an inductor component includes glass-based insulating materials, the strength of the inductor component reduces and cracks may occur in the body of the inductor component due to an impact during mount placement and/or stress during bending of a board.

In response to the problem described above, for example, Japanese Unexamined Patent Application Publication No. 2018-131353 has added a crystalline filler to glass-based insulating materials.

### SUMMARY

However, only addition of a crystalline filler of related art may lead to diffusion of metal atoms (for example, Ag) from electrodes to a body during co-sintering between the electrodes and the body when the structure is designed to achieve good electrical properties and/or the electrodes are sintered at high temperatures. This diffusion may reduce the insulation resistance of the body and cause electrochemical migration.

The present disclosure has found that use of a body with a specific structure can suppress the diffusion of the metal contained in the electrodes into the body. This can improve the reliability of electronic components in the present disclosure.

According to an aspect of the present disclosure, there is provided an electronic component including a body including a plurality of insulation layers laminated together; and two or more conductor portions disposed on or in the body, in which the insulation layers each include a glass portion and an inorganic filler, at least one of the glass portion and the inorganic filler contains SiO₂, X₂O₃, and R₂O where X is at least one of Al and B, and R is an alkali metal atom, and a relationship indicated by M^{X2O3}/(M^{SiO2}+M^{X2O3})≤0.20 and M^{R2O}/(M^{SiO2}+M^{X2O3})≥0.008 is satisfied where M^{SiO2} is mass of SiO₂, M^{X2O3} is mass of X₂O₃, and M^{R2O} is mass of R₂O.

In the embodiment described above, since at least one of the glass portion and the inorganic filler has the structure described above, the diffusion of metal atoms contained in the electrode into the body can be suppressed. As a result, reduction in the insulation resistance of the body can be suppressed, and occurrence of electrochemical migration can be suppressed. For example, even in high temperature firing, good co-sintering performance between the electrodes and the body can be achieved. This can improve the reliability of the electronic component. It should be noted that M^{SiO2}, which is the mass of SiO₂, refers to the mass of SiO₂ contained in the glass portion and the inorganic filler. M^{X2O3}, which is the mass of X₂O₃, refers to the mass of X₂O₃ contained in the glass portion and the inorganic filler. M^{R2O}, which is the mass of R₂O, refers to the mass of R₂O contained in the glass portion and the inorganic filler.

In one aspect, the glass portion contains SiO₂, X₂O₃, and R₂O.

In one aspect, the inorganic filler contains SiO₂, X₂O₃, and R₂O.

In addition, according to another aspect of the present disclosure, there is provided an electronic component including: a body including a plurality of insulation layers laminated together; and two or more conductor portions disposed on or in the body, in which a relationship indicated by (Y−X)/Y×100≤15 is satisfied where X is a Young's modulus at a location 10 μm inside the body from a surface on which the conductor portions are in contact with the body, and Y is a Young's modulus at a location 30 μm inside the body.

In the embodiment described above, since a certain relationship is present between the Young's modulus at the location 10 μm inside, which is close to the conductor portions, and the Young's modulus at location 30 μm inside, which is away from the conductor portions, the co-sintering performance between the conductor portions (for example, Ag) and the body becomes good, and the diffusion of metal atoms into the body from the conductor portions can be significantly suppressed. This can improve the reliability of the electronic component.

According to the present disclosure, the diffusion of the metal contained in the conductor portions into the body can be suppressed, and accordingly, the reliability of electronic components can be improved by using the body with specific physical properties.

### BRIEF DESCRIPTION OF THE DRAWINGS

FIG. 1 is a perspective view illustrating an inductor component according to a first embodiment of the present disclosure; and

FIG. 2 is an exploded perspective view of the inductor component.

### DETAILED DESCRIPTION

An inductor component that is an example of an electronic component will be described in detail below by using illustrated embodiments. It should be noted that some of the drawings are schematic and do not necessarily represent actual dimensions or ratios. In addition, when using a similar body, even electronic components other than inductor component can suppress the diffusion of the metal contained in conductor portions into the body, and accordingly, the effect of improving the reliability of the electronic component can be obtained. Examples of the electronic component described above include a capacitor, a chip resistor, and the like.

### First Embodiment

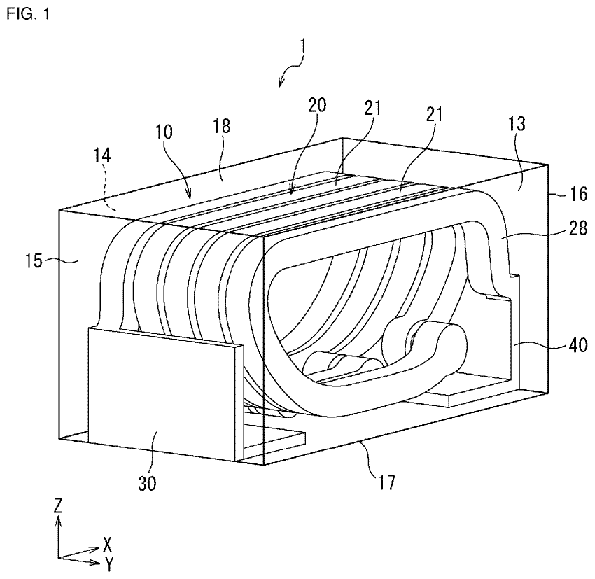

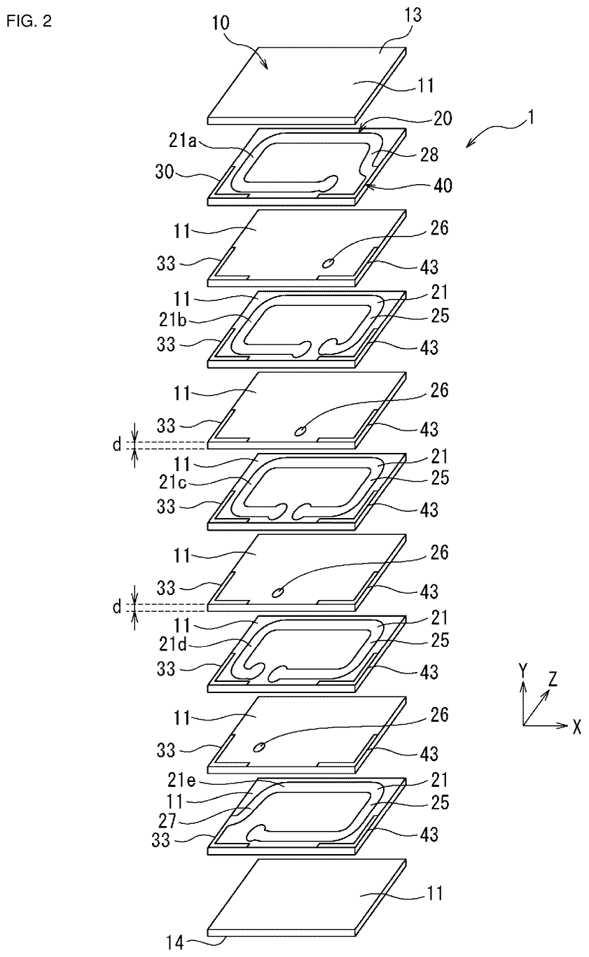

FIG. 1 is a perspective view illustrating an inductor component according to a first embodiment. FIG. 2 is an exploded perspective view of the inductor component. As illustrated in FIGS. 1 and 2, the inductor component 1 includes a body 10, a spiral coil 20, provided in the body 10, that includes a plurality of stacked coil wiring lines 21, first and second extended wiring lines 27 and 28, provided in the body 10, that are connected to both end portions of on one side of the coil 20, a first outer conductor portion 30 connected to the first extended wiring line 27, and a second outer conductor portion 40 connected to the second extended wiring line 28. The coil 20, the first and second extended wiring lines 27 and 28, and the first and second outer conductor portions 30 and 40 are electrically connected to each other. It should be noted that the body 10 is illustrated transparently in FIGS. 1 and 2 to facilitate the understanding of the structure.

The inductor component 1 is electrically connected to a wiring line of a circuit board, which is not illustrated, via the first and second outer conductor portions 30 and 40. The inductor component 1 is used as, for example, a coil (matching coil) for matching the impedance of a high-frequency circuit and is used in electronic devices, such as a personal computer, a DVD player, a digital camera, a TV, a mobile phone, a car electronics, and medical and industrial machinery. However, the application of the inductor component 1 is not limited to this example and can also be used in, for example, a tuning circuit, a filter circuit, and a rectification smoothing circuit.

The body 10 is formed in a substantially rectangular parallelepiped shape. The surfaces of the body 10 include a first end face 15, a second end face 16 that faces away from the first end face 15, a first side surface 13 connected between the first end face 15 and the second end face 16, a second side surface 14 that face away from the first side surface 13, a bottom surface 17 connected between the first end face 15 and the second end face 16, and a top surface 18 that faces away from the bottom surface 17. It should be noted that an×direction is the direction orthogonal to the first end face 15 and the second end face 16, a Y direction is the direction parallel to the first and second end faces 15 and 16 and the bottom surface 17 and orthogonal to the first side surface 13 and the second side surface 14, and a Z direction is the direction orthogonal to the X direction and the Y direction and orthogonal to the bottom surface 17 and the top surface 18. The body 10 has, for example, a length of 400 μm in the X direction, a length of 200 μm in the Y direction, and a length of 200 μm in the Z direction.

The body 10 includes the plurality of insulation layers 11 laminated together. The lamination direction of the insulation layers 11 is the Y direction, which is orthogonal to the first and second end faces 15 and 16 and the bottom surface 17 of the body 10. That is, the insulation layers 11 have a layered structure that extends along an XZ plane. “Vertical” in this application is not limited to a strictly vertical state and also includes a substantially vertical state in consideration of a practical variation range. It should be noted that the interface between the plurality of insulation layers 11 of the body 10 is not necessarily be clear due to firing or the like. The insulation layers 11 has a uniform thickness d.

The first outer conductor portion (for example, a first electrode) 30 has an L-shape extending from the first end face 15 to the bottom surface 17. The second outer conductor portion (for example, a second electrode) 40 has an L-shape extending from the second end face 16 to the bottom surface 17. It should be noted that the first outer conductor portion 30 and the second outer conductor portion 40 may have other shapes. For example, the portions may be conductor portions (for example, five-surface electrodes) that cover five surfaces or may be conductor portions (for example, bottom surface electrodes) that cover the bottom surface.

The first outer conductor portion 30 and the second outer conductor portion 40 include a conductive material, such as, for example, Ag or Cu, and glass particles. The first outer conductor portion 30 has a structure in which a plurality of first outer conductor portion conductor layers 33 embedded in the body 10 (insulation layer 11) are laminated together. The second outer conductor portion 40 has a structure in which a plurality of second outer conductor portion conductor layers 43 embedded in the body 10 (insulation layer 11) are laminated together. The first outer conductor portion conductor layers 33 extend along the first end face 15 and the bottom surface 17, and the second outer conductor portion conductor layers 43 extend along the second end face 16 and the bottom surface 17.

The first extended wire line 27 connects a first end, which is one end of the coil 20, and the first outer conductor portion 30 to each other. The second extended wiring line 28 connects a second end, which is the other end of the coil 20, and the second outer conductor portion 40 to each other. The first and second extended wiring lines 27 and 28 include a conductive material and glass particles similar to those of the coil 20.

It should be noted that the coil 20, the first and second extended wiring lines 27 and 28, and the first and second outer conductor portions 30 and 40 are integrated with each other and there is no clear boundaries in the embodiment, but the present disclosure is not limited to the embodiment, and boundaries may be present by the coil, the extended wiring lines, and the outer conductor portions being formed of different materials or formed by different methods.

The coil 20 includes a conductive material and glass particles similar to those of, for example, the first and second outer conductor portions 30 and 40. The coil 20 is wound spirally in the lamination direction of the insulation layers 11.

The shape of the coil 20 is substantially elongated oval as viewed in the axial direction but is not limited to this shape. The shape of the coil 20 may be, for example, a circular shape, an elliptical shape, a rectangular shape, or other polygons. The axial direction of the coil 20 refers to the direction that is parallel to the central axis of the spiral about which the coil 20 is wound. The axial direction of the coil 20 is the same as the lamination direction of the insulation layers 11.

The coil 20 includes the coil wiring lines 21 wound along planes. The plurality of coil wiring lines 21 are stacked together in the axial direction. Specifically, the coil wiring lines 21 include a fifth coil wiring line 21e, a fourth coil wiring line 21d, a third coil wiring line 21c, a second coil wiring line 21b, and a first coil wiring line 21a, which are stacked from the second side surface 14 to the first side surface 13 in the axial direction, and these coil wiring lines 21 are wound and formed on the main surfaces (XZ planes) of the insulation layers 11 orthogonal to the axial direction. Coil wiring lines 21 adjacent to each other in the lamination direction are electrically connected to each other in series through a via wiring 26 that passes through the insulation layers 11 in the thickness direction (Y direction). As described above, the plurality of coil wiring lines 21 are formed in a spiral shape while being electrically connected to each other in series. Specifically, the coil 20 has a structure in which the plurality of coil wiring lines 21, electrically connected to each other in series, that have a winding number of less than one turn are stacked together, and the coil 20 has a helical shape. The coil wiring line 21 includes a single layer of the coil conductor layer 25.

The distance between adjacent coil wiring lines 21, which is, for example, the distance between the first coil wiring line 21a and the second coil wiring line 21b, the distance between the second coil wiring line 21b and the third coil wiring line 21c, the distance between the third coil wiring line 21c and the fourth coil wiring line 21d, and the distance between the fourth coil wiring line 21d and the fifth coil wiring line 21e) is not particularly limited but is, for example, 0.1 μm or more and 20 μm or less (i.e., from 0.1 μm to 20 μm).

The shortest distance between the coil wiring lines 21 and the outer peripheral surface of the body 10 in a cross section, along the coil wiring lines 21, that is orthogonal to a direction in which the coil wiring lines 21 are stacked together is preferably 20 μm or less. The lower limit of the shortest distance between the coil wiring lines 21 and the outer peripheral surface of the body 10 is not particularly limited but is, for example, is 1 μm. Here, the shortest distance refers to the shortest distance between the coil wiring lines 21 and the outer peripheral surface of the body 10 located closest to the coil wiring lines 21 as viewed from the first side surface 13, which is, for example, the top surface 18, the bottom surface 17, the first end face 15, or the second end face 16.

Since the structure described above is adopted, a highly reliable electronic component that can reduce the side gap while having high Q characteristics can be supplied.

In one aspect, the shortest distance between the coil wiring lines 21 and the first end face 15 of the body 10 in a cross section, along the coil wiring lines 21, that is orthogonal to the direction in which the coil wiring lines 21 are stacked together is 20 μm or less. The lower limit of the shortest distance between the coil wiring lines 21 and the first end face 15 is not particularly limited but is, for example, 1 μm. Here, the shortest distance refers to the shortest distance between the coil wiring lines 21 and the first end face 15 as viewed from the first side surface 13.

Similarly, in one aspect, the shortest distance between the coil wiring lines 21 and the second end face 16 of the body 10 in a cross section, along the coil wiring lines 21, that is orthogonal to the direction in which the coil wiring lines 21 are stacked together is 20 μm or less. The lower limit of the shortest distance between the coil wiring lines 21 and the second end face 16 is not particularly limited but is, for example, 1 μm. Here, the shortest distance refers to the shortest distance between the coil wiring lines 21 and the second end face 16 as viewed from the first side surface 13.

In one aspect, the shortest distance between the coil wiring lines 21 and the top surface 18 of the body 10 in a cross section, along the coil wiring lines 21, that is orthogonal to the direction in which the coil wiring lines 21 are stacked together is 20 μm or less. The lower limit of the shortest distance between the coil wiring lines 21 and the top surface 18 is not particularly limited but is, for example, 1 μm. Here, the shortest distance refers to the shortest distance between the coil wiring lines 21 and the top surface 18 as viewed from the first side surface 13.

In one aspect, the shortest distance between the coil wiring lines 21 and the bottom surface 17 of the body 10 in a cross section, along the coil wiring lines 21, that is orthogonal to the direction in which the coil wiring lines 21 are stacked together is 20 μm or less. The lower limit of the shortest distance between the coil wiring lines 21 and the bottom surface 17 is not particularly limited but is, for example, 1 μm. Here, the shortest distance refers to the shortest distance between the coil wiring lines 21 and the bottom surface 17 as viewed from the first side surface 13.

### Body 10

The insulation layer 11 included in the body 10 includes a glass portion and an inorganic filler.

### Glass Portion

The glass portion is a solid having insulating properties. The glass portion contains SiO₂, X₂O₃, and R₂O. Here, X is at least one of Al and B, and R is an alkali metal atom, preferably at least one selected from the group consisting of Li, Na, K, Rb, Cs, and Fr, more preferably at least one selected from the group consisting of Li, Na, and K, for example, K. It should be noted that, since X contains at least one of Al and B, X₂O₃ to be obtained has similar physical properties.

The glass portion may further contain atoms other than those described above. For example, the glass portion may contain borosilicate glass that mainly includes B, Si, O, and K. In addition, the glass portion may contain glasses other than borosilicate glass, which are, for example, glass containing SiO₂, B₂O₃, K₂O, Li₂O, CaO, ZnO, Bi₂O₃, and/or Al₂O₃, such as SiO₂—B₂O₃—K₂O based glass, SiO₂—B₂O₃—Li₂O—CaO based glass, SiO₂—B₂O₃—Li₂O—CaO—ZnO based glass, or Bi₂O₃—B₂O₃—SiO₂—Al₂O₃ based glass. The glass portion may include a combination of two or more these glass components.

### Inorganic Filler

An average particle diameter D50 of the inorganic filler is preferably falls within the range of 0.1 μm to 5 μm, more preferably the range of 0.1 μm to 3.0 μm.

Since the inorganic filler has the average particle diameter described above, the inorganic filler can be uniformly mixed. In addition, the contamination of powder with larger particle diameters can be prevented.

The average particle diameter D50 can be measured by a general measurement method that uses an image obtained by a scanning electron microscope (SEM). The average particle diameter D50 of the inorganic filler can be obtained by measuring the inorganic filler before being added to the body 10.

The inorganic filler preferably contains at least one of Mg₂SiO₄ (forsterite), CaSiO₃ (wollastonite), ZrO₂ (zirconia), Al₂O₃ (alumina), CeO (ceria), TiO₂ (titania), Fe₂O₃ (ferrite), SiO₂ (quartz), and perovskite oxide. Since the inorganic filler described above is contained, the mechanical strength of the body 10 can be improved while desired electrical properties as the insulation layer are obtained.

The perovskite oxide can be compounds including A₁A₂O₃. A₁ and A₂ are different cations. The perovskite oxide can be BaTiO₃, (Ba, Sr)TiO₃, PbTiO₃, Pb(Zr, Ti)O₃, (Pb, La)(Zr, Ti)O₃, LiNbO₃, (LiNbO₃/Ti), K(Ta, Nb)O₃, and Pb(Mg_{1/3}Nb_{2/3})O₃, specifically BaTiO₃.

### Glass Portion and Inorganic Filler

In the glass portion and the inorganic filler, the relationship indicated by M^{X2O3}/(M^{SiO2}+M^{X2O3})≤0.20 and M^{R2O}/(M^{SiO2}+M^{X2O3})≥0.008 is satisfied where M^{SiO2} is the mass of SiO₂, M^{X2O3} is the mass of X₂O₃, and M^{R2O} is the mass of R₂O.

Since the glass portion with the composition described above is present, the diffusion of metal atoms contained in the conductor portions into the body can be suppressed, and accordingly, occurrence of electrochemical migration can be suppressed. For example, even in high temperature firing, good co-sintering performance between the conductor portions and the body can be achieved. In addition, since the diffusion of metal atoms is suppressed, reduction in the strength of the body can be suppressed. This can improve the reliability of the electronic component.

It should be noted that M^{SiO2}, which is the mass of SiO₂, M^{X2O3}, which is the mass of X₂O₃, and M^{R2O}, which is the mass of R₂O, are obtained in accordance with the values obtained by cutting the inductor component 1 in a surface, orthogonal to the top surface 18, that includes the axis and measuring the body 10 by performing analysis that uses a wavelength-dispersive X-ray fluorescence analyzer (WDX). The surface, orthogonal to the top surface 18, that includes the axis refers to the axis itself or the proximity of the axis. The proximity may allow deviation of 20% or less from the dimension in the X-axis direction of the body 10 from the axial direction of the body 10.

In one aspect, M^{X2O3}/(M^{SiO2}+M^{X2O3})≤0.10 is satisfied.

In one aspect, M^{R2O}/(M^{SiO2}+M^{X2O3})≥0.05 is satisfied.

In one aspect, M^{X2O3}/(M^{SiO2}+M^{X2O3})≤0.10 is satisfied, and M^{R2O}/(M^{SiO2}+M^{X2O3})≥0.05 is satisfied.

The volume ratio of the glass portion to the inorganic filler is not particularly limited but falls within the range between, for example, 0.4 to 0.6 and 0.8 to 0.2 inclusive.

Since the structure described above is adopted, a good mixture of the glass portion and the inorganic filler can be achieved.

### Young's Modulus

The inductor component includes two or more conductor portions. The conductor portions are disposed on or in the body 10. The relationship indicated by (Y−X)/Y×100≤15 can be satisfied where X is the Young's modulus at a location 10 μm inside the body 10 from a surface on which one of the conductor portions is in contact with the body 10, and Y is the Young's modulus at a location 30 μm inside the body 10.

Since the structure described above is adopted, occurrence of electrochemical migration can be suppressed without an increase in the distance between two or more conductor portions, and the size of the inductor component can be reduced. It should be noted that the two or more conductor portions include one conductor portion and another conductor portion adjacent to the one conductor portion, and “inside the body 10” refers to the body 10 (insulation layer 11) that is present in the direction from the one conductor portion to another conductor portion.

It should be noted that measurement of the Young's modulus can be performed by using the body 10 that has been fired at, for example, 900° C. or 940° C. In one aspect, measurement of the Young's modulus is performed by using the body 10 that has been fired at 900° C. In one aspect, measurement of the Young's modulus is performed by using the body 10 that has been fired at 940° C. X and Y are values measured by using the same body. Some variation in the firing temperature is allowed, and firing may be performed within a range of, for example, ±5° C. from a set temperature.

In one aspect, the two or more conductor portions are the first outer conductor portion 30 and the second outer conductor portion 40 disposed on the body 10. The relationship (Y−X)/Y×100≤15 is preferably satisfied, and the relationship (Y−X)/Y×100≥10 is more preferably satisfied where X is the Young's modulus at a location 10 μm from the first outer conductor portion 30 toward the second outer conductor portion 40, and Y is the Young's modulus at a location 30 μm from the first outer conductor portion 30 toward the second outer conductor portion 40.

Since the structure described above is adopted, reduction in insulation resistance caused by the diffusion of metal atoms contained in the first outer conductor portion 30 and the second outer conductor portion 40 can be suppressed, and accordingly, occurrence of electrochemical migration can be suppressed. This can enhance the reliability of the inductor component 1.

In one aspect, the two or more conductor portions are the plurality of coil wiring lines 21 disposed in the body 10. The relationship indicated by (Y−X)/Y×100≤15 is preferably satisfied, and the relationship indicated by (Y−X)/Y×100≤10 is more preferably satisfied where X is the Young's modulus at a location 10 μm from one coil wiring line 21 toward an adjacent coil wiring line 21, and Y is the Young's modulus at a location 30 μm from one coil wiring line 21 toward the adjacent coil wiring line 21.

Since the structure described above is adopted, reduction in insulation resistance due to the diffusion of metal atoms contained in the coil wiring line 21 can be suppressed, and accordingly, occurrence of electrochemical migration can be suppressed. This enhances the reliability of the inductor component 1. In addition, the surface of the coil wiring line 21 that discharges current can be smoother than the surface of the conventional coil wiring line.

It should be noted that the two coil wiring lines 21 described above may be, for example, the first coil wiring line 21a and the second coil wiring line 21b, the second coil wiring line 21b and the third coil wiring line 21c, the third coil wiring line 21c and the fourth coil wiring line 21d, or the fourth coil wiring line 21d and the fifth coil wiring line 21e.

### Diffusion Distance of Metal Atoms

The diffusion distance of metal atoms in the axial direction is, for example, 20 μm or less from the first coil wiring line 21a, the second coil wiring line 21b, the third coil wiring line 21c, the fourth coil wiring line 21d, or the fifth coil wiring line 21e when sintered at 900° C., and the diffusion distance is specifically 18 μm or less. The lower limit of the diffusion distance of metal atoms is not particularly limited but can be, for example, 1 km.

Since the structure described above is adopted, the diffusion of metal atoms can be suppressed more than usual, reduction in insulation resistance can be suppressed, and accordingly, occurrence of electrochemical migration can be suppressed.

It should be noted that some variation in the firing temperature is allowed, and firing may be performed, for example, within a range of 5° C. from a set temperature.

The diffusion distance of metal atoms in the axial direction is, for example, 20 μm or less from the first coil wiring line 21a, the second coil wiring line 21b, the third coil wiring line 21c, the fourth coil wiring line 21d, or the fifth coil wiring line 21e when sintered at 940° C., and the diffusion distance is specifically 19 μm or less. The lower limit of the diffusion distance of metal atoms is not particularly limited but can be, for example, 1 km.

Since the structure described above is adopted, the diffusion of metal atoms can be suppressed more than usual, reduction in insulation resistance can be suppressed, and accordingly, occurrence of electrochemical migration can be suppressed. Some variation in the firing temperature is allowed, and firing may be performed, for example, within a range of 5° C. from a set temperature.

### Manufacturing Method

A manufacturing method of the inductor component 1 according to an embodiment will be described.

First, an insulating paste and a conductive paste are prepared. The insulating paste includes a filler material (an example of a crystal) including quartz, a glass material (an example of a matrix) including amorphous glass, and a resin material, serving as a solvent, that contains these components.

An outer insulation layer is formed by an insulating paste being applied onto abase material, such as a carrier film. A first insulation layer is formed by the insulating paste being applied to the surface opposite to the base material of the outer insulation layer. The insulating paste is applied, for example, by screen printing. The outer insulation layer may also be produced by laminating green sheets that have been formed like sheets.

A coil conductor layer as the first layer is formed on the first insulation layer by using the conductive paste. Coil patterns are formed, for example, by pattern printing or by a photolithography patterning method when the conductive paste has photolithographic properties.

The insulating paste is applied from above the coil conductor layer as the first layer and dried to form a second insulation layer so as to cover the coil conductor layer as the first layer. Next, via holes are formed at predetermined locations of the second insulation layer formed on the coil conductor layer as the first layer. The via holes are formed, for example, by laser machining or pattern printing or formed by a photolithography patterning method when the insulating paste has photolithographic properties.

A multilayer body is formed by repeating the process of forming the coil conductor layer, the insulation layer, and via holes. After that, the inductor component 1 is produced by performing firing at, for example, 800° C. to 950° C.

It should be noted that a method that uses an insulating paste has been described in the manufacturing method described above, but the inductor component 1 may also be produced by using a general method, such as a screen printing lamination method or a sheet lamination method. Alternatively, the second insulation layer is formed after the coil conductor layer is formed in the manufacturing method described above, but the coil conductor layer may also be provided after the second insulation layer is formed in advance.

### Second Embodiment

The structure of the inductor component according to a second embodiment, which is similar to the structure of the inductor component 1 according to the first embodiment, is illustrated in FIGS. 1 and 2. It should be noted that the structure not described below is the same as that of the first embodiment and description thereof is omitted.

In the first embodiment, the body 10 includes the plurality of insulation layers 11 that are laminated together, the insulation layer 11 includes the glass portion and the inorganic filler, and the glass portion has a specific structure. However, in the second embodiment, the body 10 is provided with two or more conductor portions, and the Young's moduli of the two or more conductor portions have a specific ratio. Specifically, the inductor component includes the body 10 including the plurality of insulation layers 11 laminated together and two or more conductor portions provided in the body 10, and the relationship indicated by (Y−X)/Y×100≤15 is satisfied where X is the Young's modulus at a location 10 μm inside the body 10 from the surface on which the conductor portions and the body 10 are in contact with each other, and Y is the Young's modulus at a location 30 m inside the body 10.

Since the structure described above is adopted, the co-sintering performance between the conductor portions (for example, Ag) and the body becomes good, and the diffusion of metal atoms from the conductor portions to the body can be significantly suppressed. This can enhance the reliability of the inductor component 1.

In one aspect, the two or more conductor portions are the first outer conductor portion 30 and the second outer conductor portion 40. The relationship indicated by (Y−X)/Y×100≤15 is preferably satisfied, and the relationship indicated by (Y−X)/Y×100≤10 is more preferably satisfied where X is the Young's modulus at a location 10 μm from the first outer conductor portion 30 toward the second outer conductor portion 40, and Y is the Young's modulus at a location 30 μm from the first outer conductor portion 30 toward the second outer conductor portion 40.

Since the structure described above is adopted, reduction in insulation resistance due to diffusion of metal atoms contained in the first outer conductor portion 30 and the second outer conductor portion 40 can be suppressed, and accordingly, occurrence of electrochemical migration can be suppressed. This can enhance the reliability of the inductor component 1.

In one aspect, the two or more conductor portions are two adjacent coil wiring lines 21. The relationship indicated by (Y−X)/Y×100≤15 is preferably satisfied, and the relationship indicated by (Y−X)/Y×100≤10 is more preferably satisfied where X is the Young's modulus at a location 10 μm from one coil wiring line 21 toward an adjacent coil wiring line 21, and Y is the Young's modulus at a location of 30 μm from one adjacent coil wiring line 21 toward the adjacent coil wiring line 21.

Since the structure described above is adopted, reduction in insulation resistance due to diffusion of metal atoms contained in the coil wiring line 21 can be suppressed, and accordingly, occurrence of electrochemical migration can be suppressed. This enhances the reliability of the inductor component 1. In addition, the surface of the coil wiring line 21 that discharges current can be smoother than the surface of the conventional coil wiring line.

It should be noted that the two coil wiring lines 21 described above may be, for example, the first coil wiring line 21a and the second coil wiring line 21b, the second coil wiring line 21b and the third coil wiring line 21c, the third coil wiring line 21c and the fourth coil wiring line 21d, or the fourth coil wiring line 21d and the fifth coil wiring line 21e.

### Body 10

The insulation layer 11 included in the body 10 contains a glass portion and an inorganic filler. The glass portion, the inorganic filler, and the relationship thereof may have a structure similar to that of the first embodiment. For example, the insulation layer 11 includes the glass portion and the inorganic filler, the glass portion and the inorganic filler contain SiO₂, X₂O₃, and R₂O, X is at least one of Al and B, R is an alkali metal atom, and the relationship indicated by M^{X2O3}/(M^{SiO2}+M^{X2O3})≤0.20 and M^{R2O}/(M^{SiO2}+M^{X2O3})≥0.008 can be satisfied where M^{SiO2} is the mass of SiO₂, M^{X2O3} is the mass of X₂O₃, and M^{R2O} is the mass of R₂O.

It should be noted that the structure of the body 10 is not limited to the structure described above. For example, even when the relationship the relationship indicated by M^{X2O3}/(M^{SiO2}+M^{X2O3})≤0.20 and M^{R2O}/(M^{SiO2}+M^{X2O3})≥0.008 is not satisfied, it is possible to make adjustment such that the Young's moduli satisfy the relationship indicated by (Y−X)/Y×100≤15 by creating a low-oxygen atmosphere when the multilayer body is fired.

### Manufacturing Method

The inductor component 1 can be manufactured by the same method as in the first embodiment.

It should be noted that the present disclosure is not limited to the first and the second embodiments and the design can be changed without departing from the spirit of the present disclosure.

For example, the materials are not limited to those illustrated above and can be known materials.

The present disclosure includes the following aspects.

<1> An electronic component comprising a body including a plurality of insulation layers laminated together; and two or more conductor portions disposed on or in the body. The insulation layers each include a glass portion and an inorganic filler. Also, at least one of the glass portion and the inorganic filler contains SiO₂, X₂O₃, and R₂O where X is at least one of Al and B, and R is an alkali metal atom, and a relationship indicated by M^{X2O3}/(M^{SiO2}+M^{X2O3})≤0.20 and M^{R2O}/(M^{SiO2}+M^{X2O3})≥0.008 is satisfied where M^{SiO2} is mass of SiO₂, M^{X2O3} is mass of X₂O₃, and M^{R2O} is mass of R₂O.

<2> An electronic component comprising a body including a plurality of insulation layers laminated together; and two or more conductor portions disposed on or in the body. A relationship indicated by (Y−X)/Y×100≤15 is satisfied where X is a Young's modulus at a location 10 μm inside the body from a surface on which the conductor portions are in contact with the body, and Y is a Young's modulus at a location 30 μm inside the body.

<3> The electronic component according to <1>, wherein a relationship indicated by (Y−X)/Y×100≤15 is satisfied where X is a Young's modulus at a location 10 μm inside the body from a surface on which the conductor portions are in contact with the body, and Y is a Young's modulus at a location 30 μm inside the body.

<4> The electronic component according to <2>, wherein a relationship indicated by (Y−X)/Y×100≤10 is satisfied.

<5> The electronic component according to <3>, wherein a relationship indicated by (Y−X)/Y×100≤10 is satisfied.

<6> The electronic component according to <2> or <4>, wherein the insulation layer includes a glass portion and an inorganic filler, and at least one of the glass portion and the inorganic filler contains SiO₂, X₂O₃, and R₂O where X is at least one of Al and B, and R is an alkali metal atom.

<7> The electronic component according to <1>, <3>, or <5>, wherein M^{X2O3}/(M^{SiO2}+M^{X2O3})≤0.10 is satisfied.

<8> The electronic component according to <1>, <3>, <5>, or <7>, wherein M^{R2O}/(M^{SiO2}+M^{X2O3})≥0.05 is satisfied.

<9> The electronic component according to <1>, <3>, <5>, <7>, or <8>, wherein an average particle diameter D50 of the inorganic filler falls within a range of 0.1 μm to 5 m.

<10> The electronic component according to any one of <1>, <3>, <5>, and <7> to <9>, wherein the inorganic filler contains at least one of Mg₂SiO₄, CaSiO₃, ZrO₂, Al₂O₃, CeO, TiO₂, Fe₂O₃, SiO₂, and perovskite oxide.

<11> The electronic component according to any one of <1>, <3>, <5>, and <7> to <10>, wherein a volume ratio of the glass portion to the inorganic filler falls within a range of 0.4:0.6-0.8:0.2 inclusive.

<12> The electronic component according to any one of <1> to <11>, wherein the two or more conductor portions are a first outer conductor portion and a second outer conductor portion that are disposed on the body.

<13> The electronic component according to any one of <1> to <12>, wherein the electronic component is an inductor component.

<14> The electronic component according to <13>, wherein the inductor component includes a coil including a plurality of coil wiring lines, disposed in the body, that are stacked together, and the two or more conductor portions include the plurality of coil wiring lines.

<15> The electronic component according to <14>, further comprising a coil including a plurality of coil wiring lines, electrically connected to the first outer conductor portion and the second outer conductor portion, that are stacked together. A shortest distance between the coil wiring lines and an outer peripheral surface of the body in a cross section, along the coil wiring lines, that is orthogonal to a direction in which the coil wiring lines are stacked together is 20 μm or less.

### EXAMPLES

The present disclosure will be described more specifically through examples, but present disclosure is not limited to these examples.

### Composition Ratio of Body

In a destructive physical analysis (DPA) section obtained by embedding an electronic component in resin, solidifying the resin, and polishing the resin together with the electronic component, wavelength-dispersive X-ray (WDX) analysis of the body was performed to calculate and convert the elemental ratio (atom %).

### Diffusion Distance of Ag

WDX mapping analysis was conducted in proximity to the conductor portions (Ag) in the DPA cross section. In accordance with the detection intensity data of the obtained Ag mapping diagram, when the intensity of an Ag conductor portion was set to 100, the distance of the position of the body from the conductor portion at which the intensity becomes 1/20 was defined as an Ag diffusion distance.

### Young's Modulus Difference

A nanoindentation method was conducted on the body portion of the DPA section by using a microhardness tester (product name is DUH-201 manufactured by Shimadzu Corporation). The average value of the Young's modulus was calculated when N was set to 10. The measurement positions were a position near the conductor portion and a position away from the conductor portion, and the change rates of these positions were calculated.

### Example 1-1

The proportions of inorganic components were adjusted such that SiO₂, X₂O₃(X is Al and B), and R₂O (R is K) are contained with the ratios illustrated in Table 1. After the mixtures of these compounds were laminated together and fired at 900° C. to produce an inductor.

### Example 1-2

The mixtures obtained in Example 1-1 were laminated together and fired at 940° C. to produce an inductor.

### Examples 2 to 7

Mixtures were obtained in the same manner as in Example 1, laminated together, and fired at 900° C. and 940° C. to produce an inductor.

### Examples 8 to 11 and Comparative Examples 1 and 2

These examples and comparative examples are the same as Example 1 except that mixture was performed at the ratios illustrated in Table 2.

TABLE 1

| | Example 1 | Example 2 | Example 3 | Example 4 | Example 5 | Example 6 | Example 7 |
|---|---|---|---|---|---|---|---|
| M^{X203}/(M^{SiO2} + | 0.112 | 0.100 | 0.094 | 0.075 | 0.069 | 0.107 | 0.062 |
| M^{X203}) | | | | | | | |
| M^{R2O}/(M^{SiO2} + | 0.009 | 0.011 | 0.020 | 0.049 | 0.063 | 0.044 | 0.059 |
| M^{X203}) | | | | | | | |
| 900° C.: | 9.1 | 7.6 | 7.0 | 7.6 | 0.0 | 10.1 | 0.0 |
| (Y − X)/Y × | | | | | | | |
| 100 | | | | | | | |
| 900° C.: Ag | 12 | 6 | 4 | 2 | 1 | 11 | 1 |
| diffusion | | | | | | | |
| distance | | | | | | | |
| (μm) | | | | | | | |
| 940° C.: | 10.9 | 6.0 | 9.4 | 6.3 | 0.5 | 12.1 | 0.0 |
| (Y − X)/Y × | | | | | | | |
| 100 | | | | | | | |
| 940° C.: Ag | 13 | 10 | 9 | 4 | 1 | 16 | 1 |
| diffusion | | | | | | | |
| distance | | | | | | | |
| (μm) | | | | | | | |

TABLE 2

| | | | | | Comparative | Comparative |
|---|---|---|---|---|---|---|
| | Example 8 | Example 9 | Example 10 | Example 11 | Example 1 | Example 2 |
| M^{X203}/(M^{SiO2} + | 0.049 | 0.036 | 0.000 | 0.197 | 0.228 | 0.232 |
| M^{X203}) | | | | | | |
| M^{R2O}/(M^{SiO2} + | 0.089 | 0.108 | 0.123 | 0.049 | 0.005 | 0.005 |
| M^{X203}) | | | | | | |
| 900° C.: | 0.0 | 1.8 | 1.8 | 13.1 | 18.1 | 16.8 |
| (Y − X)/Y × | | | | | | |
| 100 | | | | | | |
| 900° C.: Ag | 1 | 8 | 3 | 18 | 30 | 28 |
| diffusion | | | | | | |
| distance (μm) | | | | | | |
| 940° C.: | 0.0 | 1.8 | 1.8 | 15.0 | 17.5 | 17.3 |
| (Y − X)/Y × | | | | | | |
| 100 | | | | | | |
| 940° C.: Ag | 1 | 4 | 5 | 19 | 34 | 35 |
| diffusion | | | | | | |
| distance (μm) | | | | | | |

As illustrated in Tables 1 and 2, in Examples 1 to 11, M^{X2O3}/(M^{SiO2}+M^{X2O3}) was 0.20 or less, M^{R20}/(M^{SiO2}+M^{X2O3}) was 0.008 or more, and (Y−X)/Y×100 was 15 or less when fired at 900° C. and 940° C. It was found that the diffusion distance of metal atoms at 900° C. and 940° C. became smaller at this time, and accordingly, the diffusion of the metal contained in the conductor portions into the body could be suppressed.

As illustrated in Table 2, in comparative examples 1 and 2, M^{X2O3}/(M^{SiO2}+M^{X2O3}) was greater than 0.20, M^{R2O}/(M^{SiO2}+M^{X2O3}) was smaller than 0.008, and (Y−X)/Y×100 was 15 or more when fired at 900° C. and 940° C. It was found that the diffusion distance of metal atoms at 900° C. and 940° C. was larger at this time, and accordingly, the metal contained in the conductor portions diffused into the body.

What is claimed is:

1. An electronic component comprising:
a body including a plurality of insulation layers laminated together; and
two or more conductor portions on or in the body,
wherein the insulation layers include a glass portion and an inorganic filler,
at least one of the glass portion and the inorganic filler includes SiO₂, X₂O₃, and R₂O where X is at least one of Al and B, and R is an alkali metal atom, and
a relationship below is satisfied:
$${M}^{X 2 O 3} / ( {M}^{S i O 2} + {M}^{X 2 O 3} ) \leq 020 , and$$
$${M}^{R 2 O} / ( {M}^{S i O 2} + {M}^{X 2 O 3} ) \geq 0.008 ,$$
where M^{SiO2} is mass of SiO₂, M^{X2O3} is mass of X₂O₃, and M^{R2O} is mass of R₂O.

2. An electronic component comprising:
a body including a plurality of insulation layers laminated together; and
two or more conductor portions on or in the body,
wherein a relationship indicated by (Y−X)/Y×100≤15 is satisfied,
where X is a Young's modulus at a location 10 μm inside the body from a surface on which the conductor portions are in contact with the body, and
Y is a Young's modulus at a location 30 μm inside the body from a surface on which the conductor portions are in contact with the body.

3. The electronic component according to claim 1, wherein
a relationship indicated by (Y−X)/Y×100≤15 is satisfied,
where X is a Young's modulus at a location 10 μm inside the body from a surface on which the conductor portions are in contact with the body, and
Y is a Young's modulus at a location 30 μm inside the body from a surface on which the conductor portions are in contact with the body.

4. The electronic component according to claim 2, wherein
a relationship indicated by (Y−X)/Y×100≤10 is satisfied.

5. The electronic component according to claim 3, wherein
a relationship indicated by (Y−X)/Y×100≤10 is satisfied.

6. The electronic component according to claim 2, wherein
the insulation layer includes a glass portion and an inorganic filler, and
at least one of the glass portion and the inorganic filler includes SiO₂, X₂O₃, and R₂O where X is at least one of Al and B, and R is an alkali metal atom.

7. The electronic component according to claim 1, wherein
M^{X2O3}/(M^{SiO2}+M^{X2O3})≤0.10 is satisfied.

8. The electronic component according to claim 1, wherein
M^{R2O}/(M^{SiO2}+M^{X2O3})≥0.05 is satisfied.

9. The electronic component according to claim 1, wherein
an average particle diameter D50 of the inorganic filler falls within a range of 0.1 μm to 5 μm.

10. The electronic component according to claim 1, wherein
the inorganic filler includes at least one of Mg₂SiO₄, CaSiO₃, ZrO₂, Al₂O₃, CeO, TiO₂, Fe₂O₃, SiO₂, and perovskite oxide.

11. The electronic component according to claim 1, wherein
a volume ratio of the glass portion to the inorganic filler falls within a range of 0.4:0.6-0.8:0.2 inclusive.

12. The electronic component according to claim 1, wherein
the two or more conductor portions are a first outer conductor portion and a second outer conductor portion which are on the body.

13. The electronic component according to claim 1, wherein
the electronic component is an inductor component.

14. The electronic component according to claim 13, wherein
the inductor component includes a coil including a plurality of coil wiring lines which are in the body and are stacked together, and
the two or more conductor portions include the plurality of coil wiring lines.

15. The electronic component according to claim 14, further comprising:
a coil including a plurality of coil wiring lines which are electrically connected to a first outer conductor portion and a second outer conductor portion of the two or more conductor portions, and are stacked together,
wherein a shortest distance between the coil wiring lines and an outer peripheral surface of the body is 20 μm or less in a cross section, along the coil wiring lines, that is orthogonal to a direction in which the coil wiring lines are stacked together.

16. The electronic component according to claim 4, wherein
the insulation layer includes a glass portion and an inorganic filler, and
at least one of the glass portion and the inorganic filler includes SiO₂, X₂O₃, and R₂O where X is at least one of Al and B, and R is an alkali metal atom.

17. The electronic component according to claim 3, wherein
M^{X2O3}/(M^{SiO2}+M^{X2O3})≤0.10 is satisfied.

18. The electronic component according to claim 3, wherein
M^{R2O}/(M^{SiO2}+M^{X2O3})≥0.05 is satisfied.

19. The electronic component according to claim 3, wherein
an average particle diameter D50 of the inorganic filler falls within a range of 0.1 μm to 5 μm.

20. The electronic component according to claim 3, wherein
the inorganic filler includes at least one of Mg₂SiO₄, CaSiO₃, ZrO₂, Al₂O₃, CeO, TiO₂, Fe₂O₃, SiO₂, and perovskite oxide.
